(19) United States
(12) Patent Application Publication
(10) Pub. No.: US 2012/0014783 A1
(43) Pub. Date: Jan. 19, 2012

(54) Apparatus For Non-Clogging Pumps

(75) Inventors: James G. Shaw, Draper, UT (US); James Northrup, Draper, UT (US); Martin Miller, Riverton, UT (US)

(73) Assignee: ENVIROTECH PUMPSYSTEMS, INC., Salt Lake City, UT (US)

(21) Appl. No.: 13/185,387

(22) Filed: Jul. 18, 2011

Related U.S. Application Data
(60) Provisional application No. 61/365,183, filed on Jul. 16, 2010.

(51) Int. Cl. F04D 29/10; F01D 5/28; F16K 24/04; F01D 5/14

(52) U.S. Cl. 415/170.1; 416/223 R; 416/241 R; 137/202

(57) ABSTRACT

Improvements in the operation and maintenance of non-clogging pumps are provided which increase pump efficiencies through improved impeller design and vacuum assembly design, and which increase seal lubrication efficiencies through improved seal lubricant reservoir system design.

### CROSS-REFERENCE TO RELATED APPLICATIONS

This is a non-provisional application which claims priority to U.S. provisional application Ser. No. 61/365,183, filed Jul. 16, 2010, the contents of which are incorporated herein, in their entirety, by reference.

### STATEMENT REGARDING FEDERALLY SPONSORED RESEARCH OR DEVELOPMENT

None.

### REFERENCE TO SEQUENCE LISTING, A TABLE, OR A COMPUTER PROGRAM LISTING COMPACT DISC APPENDIX

None.

### BACKGROUND OF THE INVENTION

1. Field of the Invention

This invention relates generally to industrial centrifugal pumps, and relates more specifically to non-clogging centrifugal pumps and design improvements that increase or improve pumping efficiencies, and facilitate maintenance of the pump.

2. Background of Related Art

Centrifugal pumps, in general, are used in a variety of industries to transport fluids. Such industries include wastewater treatment, municipal processing, the food processing industry and others. Centrifugal pumps define a broad category of types of pumps that are structured to provide the pumping capacities required for a given type of fluid processing application. The types of pump with which the present application is most concerned are pumps that are generally known as “non-clogging” pumps or self-primer pumps.

Non-clogging or self-primer pumps are generally characterized as being structured with a means for providing priming fluid to the pump in order to facilitate initiation of the pumping process. That is, pumps require an amount of fluid to be present in the pump to properly initiate the pumping process. However, centrifugal pumps may sometimes have insufficient fluid in the pump to initiate the pumping process and, under such conditions, are said the “run dry.” When there is an insufficient amount of fluid at the inlet of the pump, rotation of the impeller can cause what little fluid is in the pump to vaporize, which causes damage to the pump. Some pumps are provided with means, such as a fill port, for manually adding fluid to the pump to prevent the pump from running dry.

In non-clogging or self-priming pumps, a means by which the pump may prime itself is provided in the pump. In some self-primer pumps, the pump is provided with a vacuum assembly that is driven by the motor means which rotates the drive shaft of the pump. The vacuum assembly provides a means by which fluid can be drawn into the pump inlet or into the eye of the impeller so that the pump does not run dry. Examples of non-clogging pumps of the type relating to the present invention are described in U.S. Pat. No. 6,575,706; U.S. Pat. No. 6,616,427 and U.S. Pat. No. RE39,813.

Certain operating inefficiencies exist in conventional non-clogging pumps that result in a decrease in pump performance and an increase in maintenance costs. These inefficiencies generally include poor impeller performance, poor seal performance and compromised vacuum performance in the self-priming assembly. Therefore, means for improving the operation and maintenance of non-clogging pumps is desirable in the industry.

### BRIEF SUMMARY OF THE INVENTION

In accordance with various aspects of the disclosure, improvements in the operation and maintenance of non-clogging pumps are provided which increase pump efficiencies through improved impeller design and vacuum assembly design, and which increase seal lubrication efficiencies through improved seal lubricant reservoir design.

In accordance with one aspect of the disclosure, a seal lubricant reservoir system is structured and positioned relative to the pump housing structures to provide improved circulation of the seal lubricant to and from the seal assembly which seals the pump casing about the drive shaft. As a result, the seals have a longer service life, and maintenance requirements for the pump are reduced. The improvements in the seal lubricant reservoir system allow the seal lubricant to operate at a lower temperature than is known in conventional seal lubricant reservoir systems, thereby resulting in less wear on the seals.

In another aspect of the disclosure, the float box arrangement associated with the vacuum pull system of the self-primer apparatus is structured with improved means for supporting the float elements during periods when no vacuum is exerted on the float box elements. In prior float box constructions, the floating elements of the float box are structured and positioned to hang in such a manner that, during times when no vacuum is exerted on the system, the float elements are subject to wear, and eventual failure. The float box construction of the present disclosure provides support means for retaining the movable floating elements of the float box in a fixed position during periods of non-vacuum conditions so that the elements are not subject to degradation. Thus, the service life of the float box elements is increased and maintenance requirements are advantageously decreased.

In another aspect of the disclosure, an impeller for use in a non-clogging or self-primer pump is designed to increase the solids processing capacity of the impeller while simultaneously improving the pumping efficiencies of the pump. The ability to increase the solids processing capacity while improving pumping efficiency has not, heretofore, been achieved. The particular structural changes that have been incorporated into the design of the impeller improve the solids processing capacities while also improved pumping efficiencies. Furthermore, the structural design of the impeller has been developed to uniquely enable the improved impeller design elements to be achieved by casting methods when, heretofore, similar structural changes to the impeller were achievable only through manual modifications.

The foregoing improvements in the structural elements of a non-clogging pump, alone and collectively, provide increased pumping efficiencies in such pumps and, at the same time, reduce the amount of maintenance required in servicing known constructions of non-clogging or self-primer pumps. These and other advantages of the aspects of the disclosure will be understood further in reference to the detailed description and illustrations set forth hereinafter.

### BRIEF DESCRIPTION OF THE SEVERAL VIEWS OF THE DRAWINGS

In the drawings, which depict what is currently considered to be the best mode for carrying out the various aspects of the disclosure:

FIG. 1 is a perspective view of a non-clogging pump of the present disclosure;

FIG. 2 is a side view in elevation of the pump illustrated in FIG. 1, showing the improved seal lubrication reservoir system construction of the present disclosure;

FIG. 3 is a side view in elevation of the pump illustrated in FIG. 1 rotated 180 degrees to the right about an axis lying in the plane of the page;

FIG. 4 is an exploded view of the elements of the seal lubrication reservoir system shown in FIGS. 1-3;

FIG. 5 is a side view in elevation of the bracket which supports the seal lubrication reservoir on the bearing housing of a pump;

FIG. 6 is a plan view of the underside of the bracket shown in FIG. 5;

FIG. 7 is an end view in elevation of the bracket shown in FIG. 5;

FIG. 8 is an orthographic view of the underside of the bracket shown in FIG. 5;

FIG. 9 is view in cross section of a float box for a vacuum-assisted self-primer apparatus of a non-clogging pump in accordance with the present disclosure;

FIG. 10 is a view in cross section through the plane in which the axis of an impeller lies, according to one aspect of the present invention;

FIG. 11 is a view of the impeller shown in FIG. 10 the cross section of which is not in a plane in the axis of the impeller;

FIG. 12 is a plan view of an impeller of the known art;

FIG. 13 is a plan view of an impeller in accordance with the present disclosure;

FIG. 14 is a graph illustrating the performance improvements achieved with the impeller of the present disclosure in comparison to a known impeller of a non-clogging or self-primer pump; and

FIG. 15 is a graph illustrating improved pump efficiency achieved by the impeller of the present disclosure in comparison to a known impeller of a non-clogging or self-primer pump.

### DETAILED DESCRIPTION OF THE INVENTION

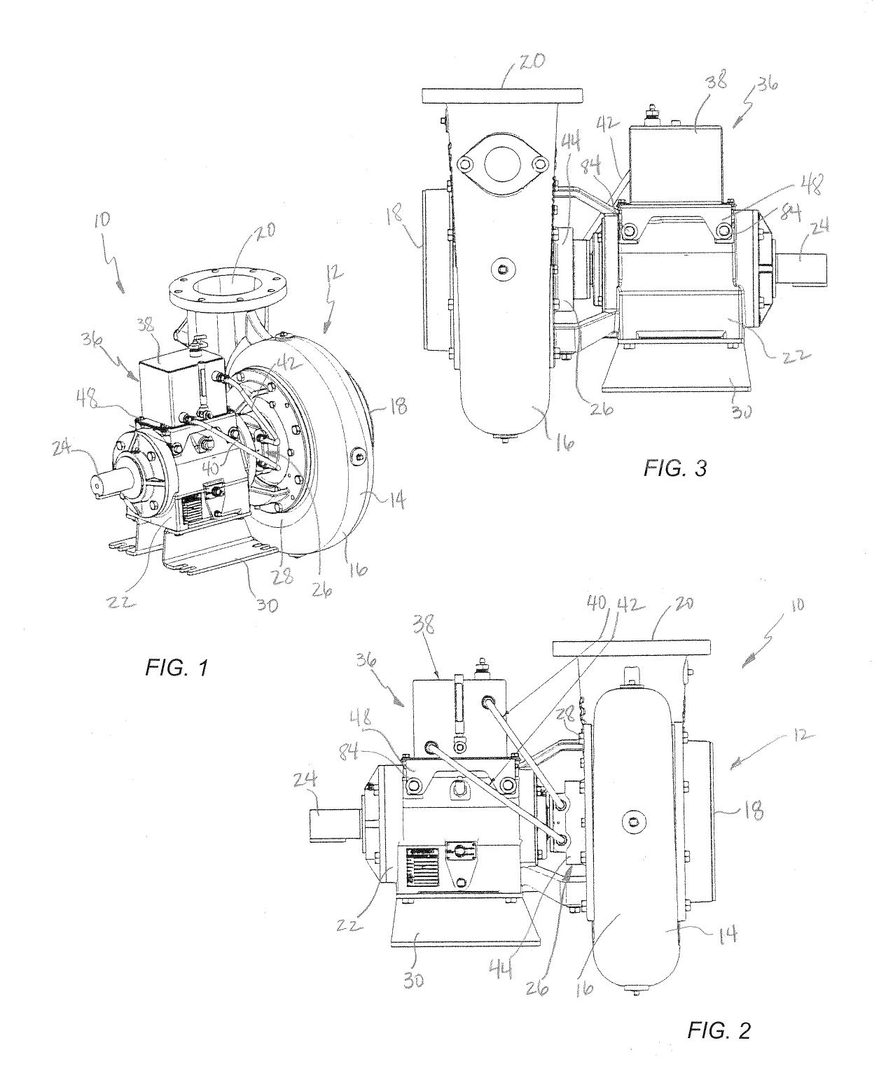

FIGS. 1-3 illustrate an example of a non-clogging or self-primer pump 10 to which the improved apparatus disclosed herein are directed. The pump 10 generally comprises a wet end 12 which, in turn, comprises a pump casing 14 having a volute 16, an inlet 18 and a discharge 20. The pump casing 14 is secured to a bearing housing 22 through which a drive shaft 24 extends. The drive shaft 24 also extends through a seal housing 26 positioned on the drive side 28 of the pump casing 14, and extends into the volute 16 of the pump casing 14 where it is operatively connected to an impeller (not shown), as is conventionally known in the art. The bearing housing 22 may be secured to a pedestal 30 which, in turn, is typically bolted to a support surface.

In accordance with a first aspect of the disclosure, a seal lubricant reservoir system 36 is positioned above and secured to the bearing housing 22 of the pump 10. The seal lubricant reservoir system 36 comprises a reservoir 38 that has an internal compartment for retaining a lubricant used to lubricate the seal assembly 26 of the pump 10. The seal lubricant reservoir system 36 further comprises two conduits 40, 42 which extend between the reservoir 38 and the seal assembly 26 of the pump.

The seal assembly 26 of a pump, as is conventionally known in the pump arts, comprises at least one seal member that surrounds the drive shaft to isolate the impeller and/or pump casing from the atmosphere so that fluid, which may migrate between the back of the impeller and the back plate or drive side structure of the casing, does not leak from about the drive shaft to a point outside the pump casing.

As shown in FIGS. 1-3, the seal assembly 26 may further comprise a seal housing 44 that surrounds the drive shaft 24 and encloses the seal within. The seal housing 44 provides an internal chamber in which lubricant from the seal lubricant reservoir system 36 circulates to lubricate the seal (not shown). As is well known in the art, the friction forces acting on the seal cause the seal to become heated as the drive shaft 24 rotates. The seal must, therefore, be lubricated to cool the seal and reduce the friction forces.

The seal lubricant reservoir system 36, in accordance with the present disclosure, is structured and positioned to provide improved circulation of seal lubricant, such as oil or any other suitable lubricant, to and from the seal housing 44. It was discovered that by positioning the seal lubricant reservoir 38 in closer proximity to the seal assembly 26, thermal cycling of the lubricant to and from the seal assembly was improved and, as a result, the seal of the seal assembly 26 is able to operate at a cooler temperature than is achievable with prior art seal lubricant systems, thereby extending the service life of the seal.

Improved performance of the seal lubricant reservoir system 36 was first achieved by designing a new means for attaching the reservoir 38 to the bearing housing 22. In prior pumps which employ an external seal reservoir, the means for securing the lubricant reservoir to the pump requires the reservoir to be positioned at a considerable distance from the seal assembly. By developing a new means for attaching the reservoir 38 to the bearing housing 22, the inventors were able to improve not only the thermal cycling characteristics of the lubricant to extend the service life of the seal, but improved the ability to more efficiently effect repair and maintenance on the bearing housing 22 and the reservoir 38.

Specifically, the means for attaching the reservoir 38 to the bearing housing 22 comprises a bracket 48 that is structured to be received by, and to be secured in position above, the bearing housing 22, as illustrated in FIGS. 1-3. The bracket 48 is structured to receive the reservoir 38 of the seal lubricant reservoir system 36 and to be secured to the reservoir 38.

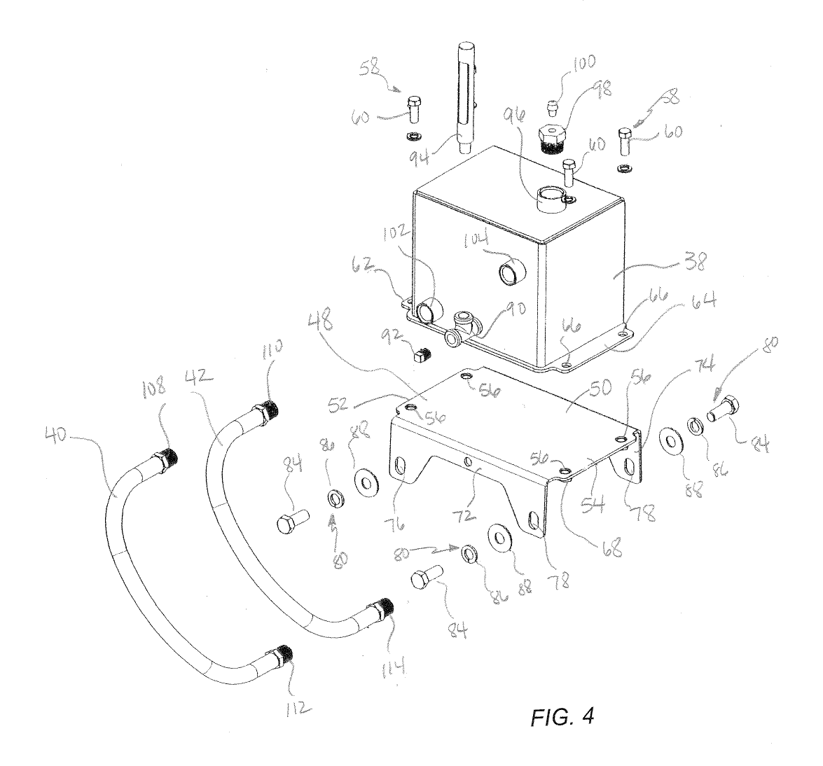

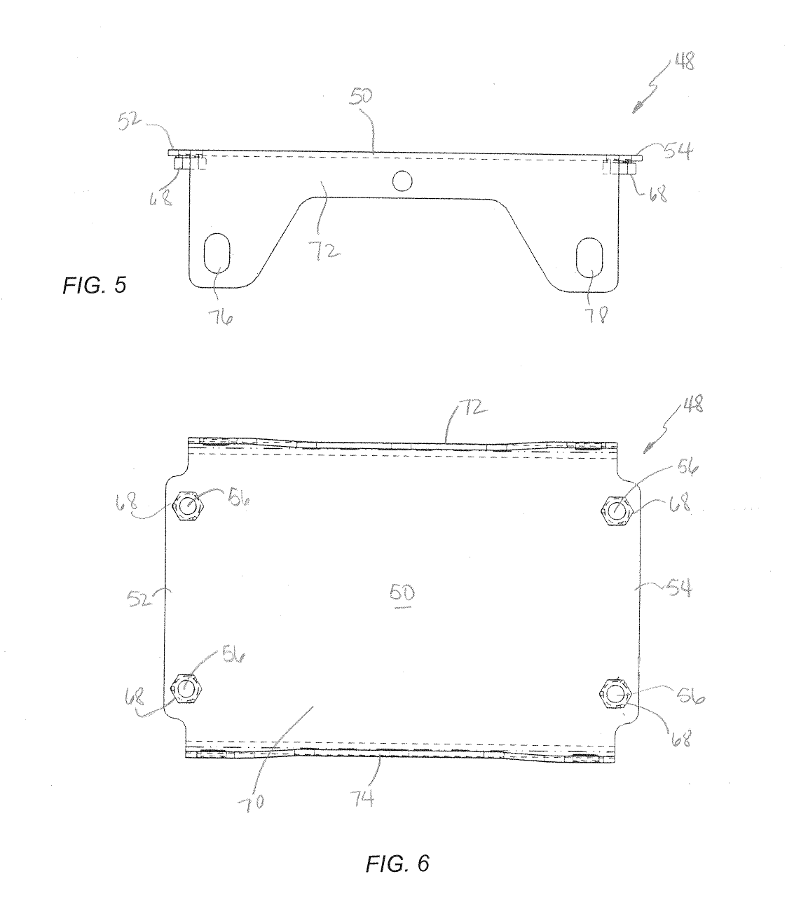

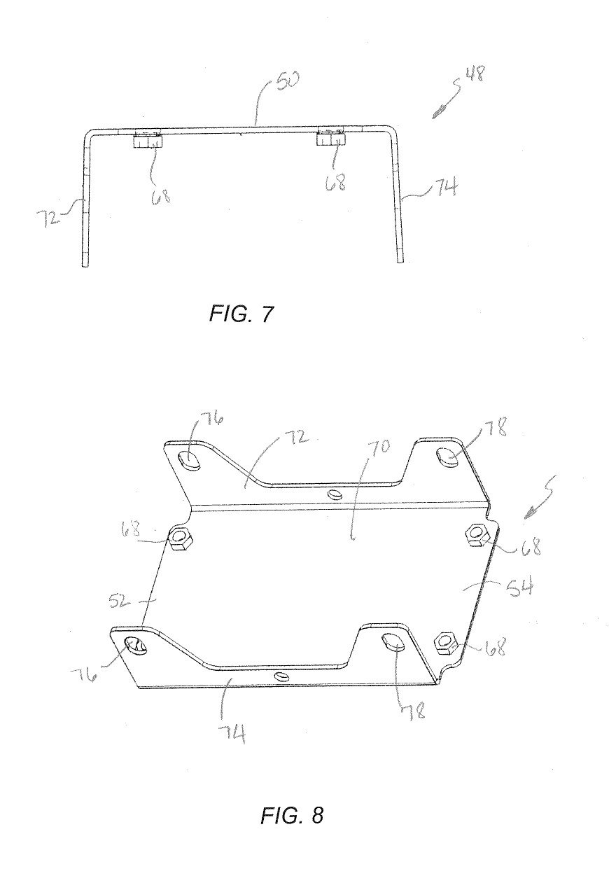

As shown more specifically in FIGS. 4-8, the bracket 48 is configured with a flat support surface 50 for receiving the reservoir 38 thereon. A flange 52, 54 extends outwardly from opposing ends of the bracket 48 in a common plane with the flat surface 50 of the bracket 48. Each flange 52, 54 is configured with at least one opening 56 through which an attachment device 58, such a bolt 60, may be positioned to secure the reservoir 38 to the bracket 48, as best seen in FIG. 4. The reservoir 38 may similarly be structured with a flange 62, 64 at either end, each flange 62, 64 being configured with at least one opening 66 (here shown as multiple openings 66) through which the bolts 60 are positioned to secure the reservoir 38 to the bracket 48. Corresponding securement nuts 68, as best seen in FIGS. 6-8, are carried on the underside 70 of the bracket to secure the bolts 60.

Along the two other opposing sides of the bracket 48, a side fin 72, 74 extends at an angle of approximately 90° away from the flat support surface 50. Each side fin 72, 74 is formed with two spaced apart openings 76, 78 which are sized to receive a securement device 80 therethrough. As illustrated, in FIGS. 1-4, the securement device 80 may be a bolt 84, with associated lock washer 86 and flat washer 88. Other types or manner of securement devices may be equally suitable. The securement devices 80 attach to corresponding openings (not shown) provided in the bearing housing 22 so that the bracket 48 may be bolted to the bearing housing 22.

Further structures of the seal lubricant reservoir system 36 are shown in FIG. 4. The reservoir 38 may be structured with a port 90 for filling or draining the reservoir 38 of lubricant. The port 90 is closed with a threaded plug 92. A level gauge 94 may be fitted to the reservoir 38, and may be attached to the port 90, to enable monitoring of the lubricant level in the reservoir 38. The reservoir 38 is also structured with a vent opening 96 which receives a threaded vent plug 98 having an aperture to receive a valve 100 therein for allowing air to escape from the reservoir 38. The reservoir 38 is also structured with conduit openings 102, 104 to which an end 108, 110 of the conduits 40, 42, respectively, attach, preferably by threaded means. The opposing end 112, 114 of each conduit 40, 42 is secured to the seal assembly 26, as depicted in FIGS. 1 and 2.

The bracket 48 described herein is structured to securely attach the reservoir 38 to the bearing housing 22, but is also uniquely structured to orient the securement devices 80, or long axis of the bolts 84, parallel to the plane of the support surface 50 of the bracket 48, and, therefore, parallel to a support surface on which the pump sits, as opposed to prior art attachment systems that are structured with bolts that secure the reservoir to the bearing housing in a manner that orients the long axis of the bolts at a perpendicular angle to the support surface on which the pump sits. Further, in prior art pumps, the securement apparatus, or bolts, are positioned beneath a support structure to which the reservoir and other pump structures are attached so that access to the securement apparatus, or bolts, is very difficult, and removal of the reservoir for maintenance or repair is very difficult. The bracket 48 structure of the present disclosure overcomes these difficulties in its design and orientation.

Additionally, however, the design of the bracket 48 enables the reservoir 38 to be positioned at a vertical level, relative to the seal of the seal assembly 26, that is closer to the seal than is achievable in previously known pumps. Consequently, the conduits 40, 42 that extend from the reservoir 38 to the seal assembly 26 are positioned to improve thermal cycling of the lubricant as is circulates from the reservoir 38, through conduit 40, into the internal chamber formed within the seal housing 44, and back through the conduit 42 to the reservoir 38.

Thermal cycling of the lubricant is achieved by the angle and vertical positioning of the conduits 40, 42 relative to the seal assembly 26 by virtue of the vertical positioning of the reservoir 38 relative to the seal assembly 26. Consequently, positioning of the support surface 50 of the bracket 48, and thus the bottom of the reservoir 38, from the axis of rotation of the drive shaft 24 is preferably within a range of between about five inches to about five and one half inches (between about 12 centimeters and 15 centimeters). This represents about a 37% to 39% reduction in height of the reservoir relative to the rotational axis of the drive shaft as compared with prior art seal lubricant reservoir placement. As a result of the positioning of the conduits 40, 42, the lubricant can cycle through the seal lubricant system 36 at a lower temperature than is achievable with prior pumps. The resulting benefit is that the seal is not subjected to as a high a lubricant temperature as is required in prior known pumps to achieve cycling of the lubricant, and the service life of the seal is advantageously increased.

In another aspect of the disclosure, an improved float box for a self-primer pump is provided. As is known in the pump arts, one design of a self-primer pump provides a vacuum-assist mechanism that facilitates the priming of the pump. An example of a vacuum-assist mechanism is described in U.S. Pat. No. 6,575,706. The vacuum-assist mechanism generally comprises a vacuum pump assembly that is positioned on or near the outboard end of the bearing housing and is operatively connected to the drive shaft of the pump. The vacuum pump communicates with a float box that is positioned at the suction end of the pump, near the inlet of the pump. The float box may, most suitably be connected to a flanged intake pipe that connects to the pump casing at the inlet of the pump. The connection of the float box to the intake pipe defines an opening through which fluid may be drawn from the intake pipe to the float box.

As is well known, when the pump is initially started, the drive shaft begins to rotate, which likewise causes rotation of a drive shaft in the vacuum pump to operate, thereby producing a vacuum pressure. The vacuum force produced by the vacuum pump is transmitted to the float box via a hose that extends between the vacuum pump and the float box. The vacuum force transmitted to the float box causes fluid to be drawn from the intake pipe and toward the inlet of the pump to provide priming fluid for operation of pump. Fluid is also drawn from the inlet pipe into the float box by the vacuum force exerted on the float box. The float box is provided with a mechanism that terminates the vacuum force when a selected amount of fluid is drawn into the float box, which in turn causes the vacuum pump to cease its operation.

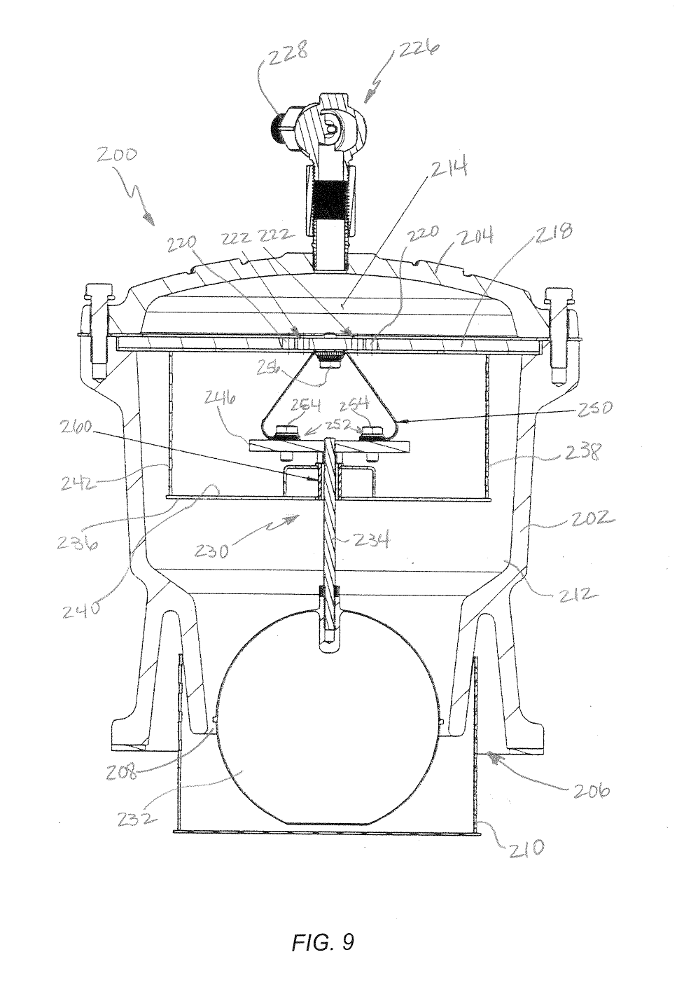

In this aspect of the disclosure, an improved float box 200, as illustrated in FIG. 9, is structured to provide more efficient operation of the float box and to extend the service life of the float box 200. In prior float boxes, the mechanism by which the float box operates to terminate the vacuum force breaks easily, thereby requiring frequent repair or replacement of the float box or its constituent elements.

The float box 200 of the present invention comprises a housing 202 having a removable top 204 secured to a fluid-receiving chamber 212. The fluid-receiving chamber 212 has an open bottom portion 206 defining a fluid intake opening 208. An apertured vacuum filter collar 210 may be positioned about the fluid intake opening 208 to prevent solid material from being drawn into the fluid-receiving chamber 212 of the housing 202.

The float box 200 is structured with an upper vacuum area 214, which is separated from the fluid chamber 212 by a plenum 218 that has a plurality of holes 220 formed through the thickness of the plenum 218. The holes 220 define vacuum ports 222, the purpose of which is described more fully below. To the top 204 of the housing 202 is secured a vacuum conduit 226 that is fitted with a coupling 228 to receive a hose (not shown) from a vacuum source, such as a vacuum pump (not shown).

A float mechanism 230 is retained within the fluid-receiving chamber 212 of the housing 202 and is generally comprised of a float ball 232 that is suspended from a float arm 234 to which the float ball 232 is secured. The float mechanism 230 further includes support member 236 that is suspended from the plenum 218. The support member 236 may, for example, be structured as a fenestrated cage 238 having a platform 240 and a circumferential wall portion 242 to which the platform 240 is formed or secured.

The float arm 234 of the float mechanism 230, at an end opposite the attachment of the float ball 232, is secured to an attachment member 246. An elastomer seal member 250 is secured to the attachment member 246 by securement means 252, such as a plurality of screws 254. Other securement means 252 are equally suitable for attaching the elastomer seal member 250 to the attachment member 246, such as rivets, adhesives or other suitable devices. The elasomer seal member 250 is also attached to the plenum by appropriate means, such as a screw 256. A float limiting collar 260 is attached to the attachment member 246 and is positioned between the attachment member 250 and the support member 236.

When a vacuum is exerted on the float box 200 through the vacuum conduit 226 that is attached to a source of vacuum, vacuum pressure is likewise exerted on the fluid-receiving chamber 212 via the vacuum ports 222 formed in the plenum 218. By application of the vacuum force, fluid is drawn into the fluid-receiving chamber 212 through the fluid intake opening 208. As fluid enters and fills the fluid-receiving chamber 212, the float ball rises, thereby causing the float arm 234 to move upwardly. The attachment member 246 is, in turn, caused to move upwardly taking with it the elastomer seal member 250. As a sufficient amount of fluid has been drawn into the fluid-receiving chamber 212, the elastomer seal member 250 is brought closer to the plenum until the elastomer seal member 250 eventually registers against and occludes the vacuum ports 222. With sealing of the vacuum ports by the elastomer seal member 250, the vacuum pressure exerted on the fluid-receiving chamber 212 is terminated.

When the pump 10 is stopped or loses prime, the elastomer seal member 250 is urged downwardly by gravity exerted upon the attachment member 246, simultaneously with the evacuation of fluid from the fluid-receiving chamber 212. As the attachment member 246 floats downwardly, the float limiting collar 260, which is attached to the underside of the attachment member 246, eventually comes to rest on the support member 236. The weight of the float ball 232, as well as the weight of the attachment member 246, is thereby supported and the elastomer seal member 250 is not put in stress by having to support the weight of those elements.

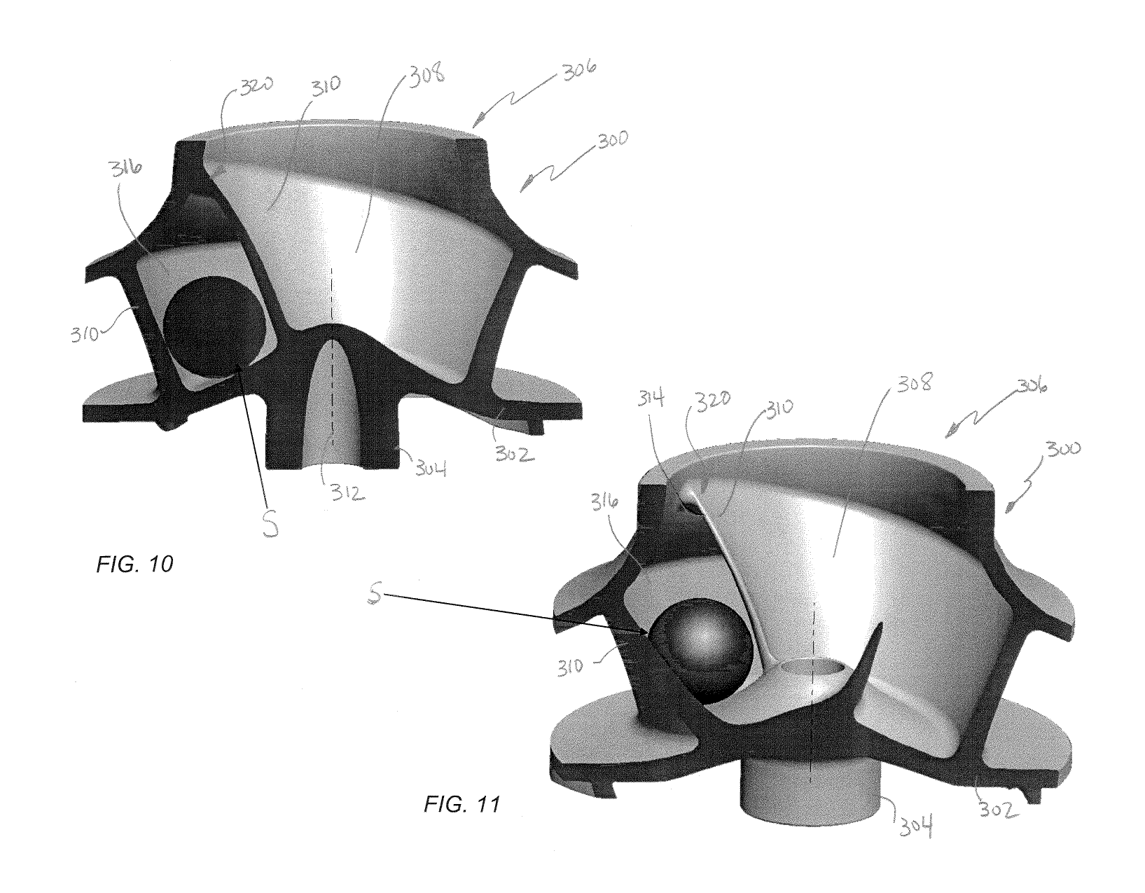

In yet another aspect of the disclosure, an improved impeller for a non-clogging or self-primer pump is illustrated in FIGS. 10-13. The impeller 300 is of an open type having a back shroud 302 that, when in the pump casing, is oriented toward the drive side 28 of the pump casing 14 (FIG. 2). A central hub 304 is structured to receive the terminal end of a drive shaft in the conventional manner, and the shroud extends radially outward from the hub. The suction side 306 of the impeller 300 is open to orient the eye 308 of the impeller 300 toward the inlet 18 of the pump 10 (FIG. 2).

The impeller 300 is formed with a plurality of blades or vanes 310 which each extend from near the hub 304 and spiral about the central axis 312 of the impeller 300. Each vane 310 is configured with a leading edge 314. The spiraling length of the vanes 310 overlap to produce a fluid pathway 316 between adjacent spiraling vanes 310. While the impellers of non-clogging pumps are required to be capable of passing solids S of at least three inches in diameter, many known impellers of non-clogging pumps do not have the requisite capacity, or at least have difficulty passing solids of that size. Therefore, the present impeller 300 was specifically designed to pass three inch solids.

Accordingly, the vanes 310 of the impeller 300 have been configured to provide enlarged pathways 316 between adjacent vanes. In order to achieve larger pathways 316, it was found that decreasing the thickness of the vane 310 at the outermost region 320 of the leading edge 314 would provide greater capacity in the pathways 316. However, it is well known in the industry that decreasing the vane thickness near the outermost region of the vane is undesirable because the thinner leading edge subjects the vane to degradation from high velocity fluid and the solids contained in the fluid.

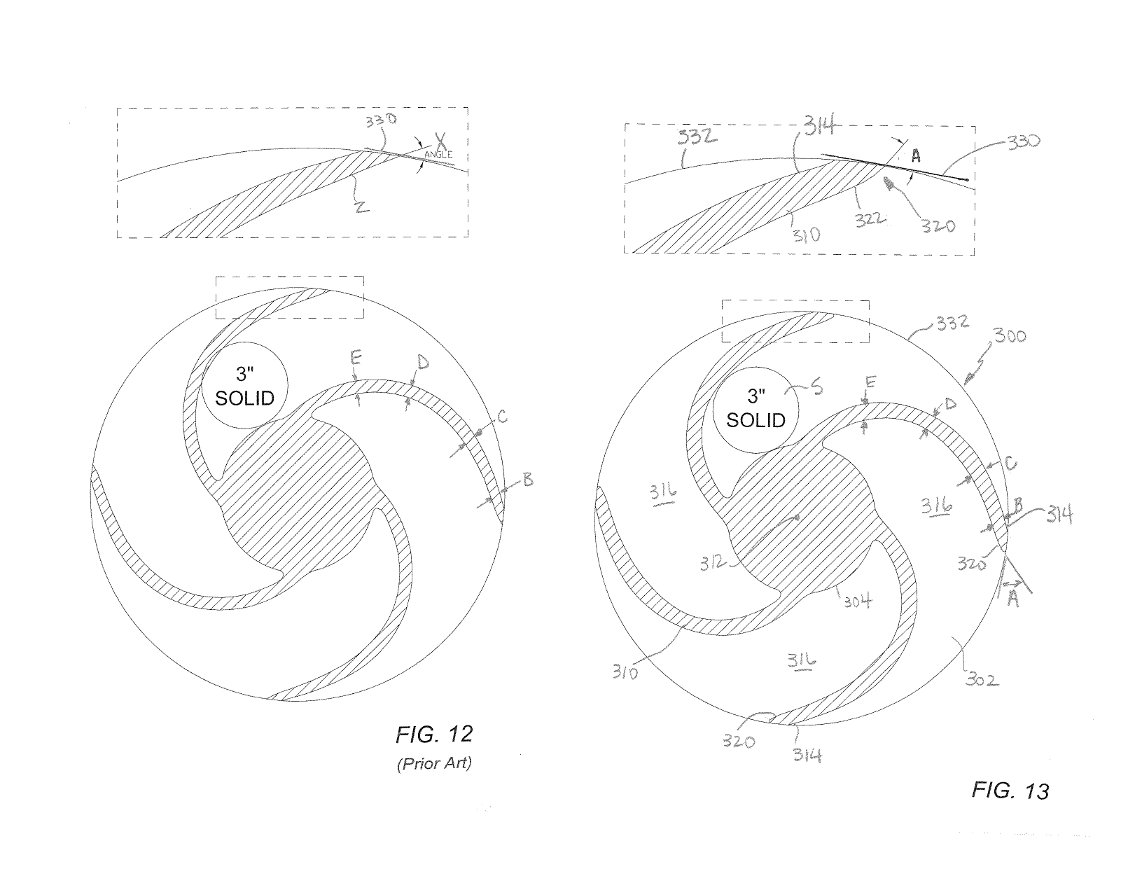

The impeller 310 of the present disclosure achieves a thinning of the outermost portion 320 of the leading edge 314 of the vane, and unexpectedly improves the performance of the impeller 310, by backfiling the back side 322 of leading edge 314 to produce a wider angle A at the outermost portion 320 of the vane 310, as compared to known impellers, as shown in FIG. 12. In tandem with backfiling of the leading edge 314 of the vane 310, the thickness of the vane 310 is increased in a direction away from the leading edge 314 preceding the curvature of the vane 310 to meet the hub of the impeller 300. These configuration changes in the vanes 310, as compared to known impellers, are illustrated in FIGS. 12 and 13. Unexpectedly, increasing the thickness of the vane 310 results in a larger pathway 316 capable of passing three inch solids S.

The angle A of the outermost portion 320 of the leading edge 314 may be between about five degrees and about twenty-five degrees greater than the angle X of the back side Z of known impeller vanes relative to a tangent line 330 at the point of intersection of the vane 310 with the outer peripheral edge 332 of the impeller, as shown in FIG. 12. In prior art impellers, the angle X is typically about 10 degrees. The angle A of the present impeller 300, as shown in FIG. 13, may be from about 15 degrees to about 33 degrees. The degree of the angle A may be determined by the sweep of the vane and may also be dictated by the size of the impeller. The selection of the most suitable angle A may also be dictated by pump performance profiling.

The thickness of the vane 310 is increased at a point B proximate the outermost portion 320 of the vane 310, and the vane thickness increases incrementally along points B through E along the curvature of the vane 310. For example, the thickness of the vane at point B may be from about 40% to about 43% greater than the conventional impeller vane (as seen in FIG. 12); the thickness of the vane at point C may be from about 45% to about 47% greater than the conventional impeller vane; the thickness of the vane at point D may be from about 22% to about 25% greater than the conventional impeller vane, and the thickness of the vane at point E may be from about 21% to about 23% greater than the conventional impeller vane. An example of vane comparisons is shown in Table 1, below.

| Point on Vane | Prior Art Vane | Present Vane |
|---|---|---|
| B | .322 inches | .459 inches |
| C | .367 inches | .536 inches |
| D | .460 inches | .571 inches |
| E | .436 inches | .532 inches |

The ability to backfile the vanes 310 of the impeller 300 presented a further challenge in that backfiling, as known in the art, must typically be done by hand. However, if the impeller 300 is cast is High Chrome, as may be desirable for heavy duty and abrasive applications, backfiling the vane 310 cannot be done by hand given the nature of High Chrome. Therefore, manifesting the backfiling modification in casting the impeller 300 in High Chrome presents an improvement in the art.

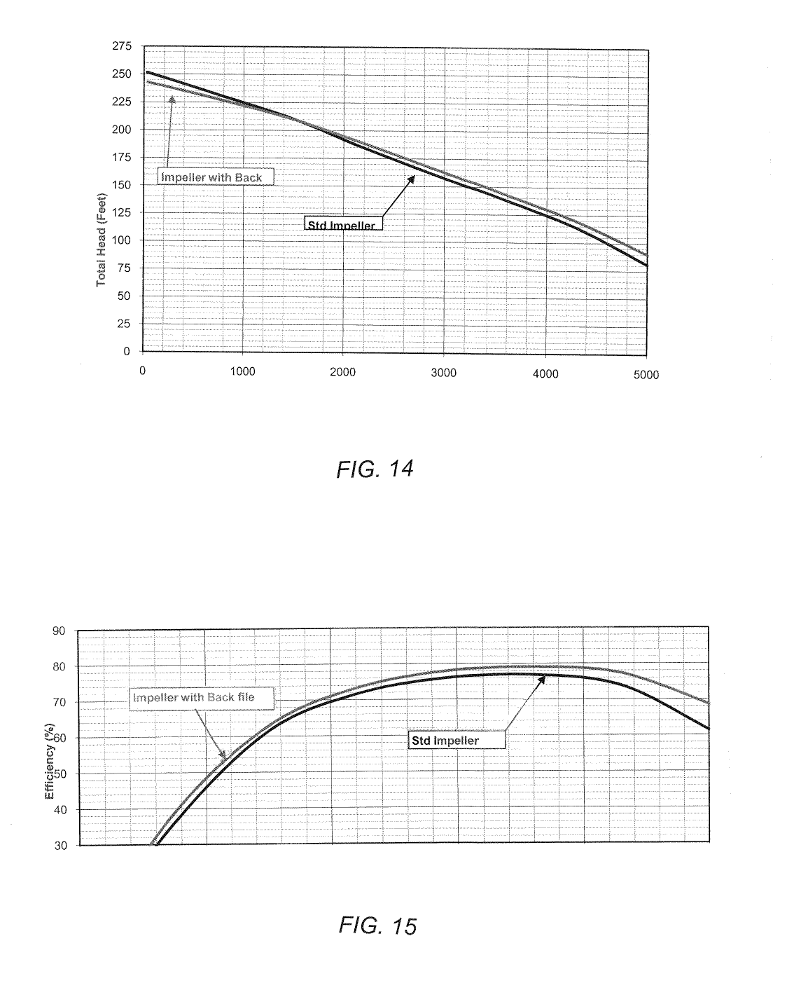

FIGS. 14 and 15 demonstrate that the impeller 300 of the present disclosure has increased performance profiles over known impellers, and the efficiency of the pump operation is increased over conventional non-clogging pumps.

The improved apparatus as disclosed herein may be modified, particularly to meet specific pump application requirements and variations in pump sizes. Therefore, reference herein to the specifics of the structural or configuration elements of the apparatus disclosed herein are by way of example only, and not by way of limitation.

1. A centrifugal pump, comprising:
a pump casing having an inlet and a discharge;
an impeller positioned within said pump casing;
a drive shaft extending through said pump casing and being operatively connected to said impeller to cause said impeller to rotate said drive shaft having an axis of rotation;
a bearing housing positioned to receive said drive shaft therethrough and positioned in proximity to said pump casing;
a seal assembly positioned about said drive shaft and located to provide a seal between said pump casing and said drive shaft; and
a seal lubricant reservoir system positioned in proximity to said bearing housing, said seal lubricant reservoir system further comprising a seal lubricant reservoir having a bottom positioned at a selected distance from said axis of said drive shaft, and two conduits extending between from said seal lubricant reservoir to said seal assembly,
wherein said selected distance between the bottom of said reservoir and said axis of rotation of said drive shaft is between about five inches and about five and one half inches.

2. The centrifugal pump according to claim 1 further comprising a bracket structured with a support surface for supporting said seal lubricant reservoir thereon.

3. The centrifugal pump according to claim 2 wherein said bracket is further structured with two opposingly positioned fins that extend away from said support surface, each fin having two spaced apart openings for receiving a securement device for securing said bracket to said bearing housing.

4. The centrifugal pump according to claim 3 wherein said securement device is a bolt having a longitudinal axis, and each said bolt positioned through each said opening is position with said longitudinal axis of said bolt being in parallel orientation to the plane of said support surface of said bracket.

5. The centrifugal pump according to claim 4 wherein said bolts are located below and spaced from the seal lubricant reservoir.

6. The centrifugal pump according to claim 1, further comprising a float box connected in proximity to the inlet of the centrifugal pump, said float box comprising a housing having a fluid-receiving chamber with a fluid intake and a vacuum chamber separated by a plenum having a plurality of vacuum ports formed therethrough, said float box further comprising a float mechanism positioned within said housing comprising a float ball, an elastomer seal member, and a float limiting collar, said float box having a vacuum conduit for attachment to a source of vacuum.

7. The centrifugal pump according to claim 6, wherein said float mechanism further comprises a support member for receiving said float limiting collar thereagainst when no vacuum is provided to said fluid-receiving chamber.

8. The centrifugal pump according to claim 1, wherein said impeller is an open impeller having a plurality of spiraling vanes forming pathways between adjacent spiraling vanes, each said vane having a leading edge an outermost portion of which is structured with an angle that is between about 12 degrees and about 33 degrees to a tangent line formed along a peripheral edge of said impeller.

9. The centrifugal pump according to claim 8, wherein each said vane of said impeller has a thickness the dimension of which increases from said outermost region of said leading edge of each said vane along the curvature of the vane toward the hub of the impeller.

10. A float box for a self-primer centrifugal pump having a vacuum source associated with the centrifugal pump for providing priming fluid to the inlet of the centrifugal pump, comprising;
a housing having a fluid-receiving chamber with an open bottom portion and a vacuum chamber separated by a plenum having a plurality of vacuum ports;
a float mechanism positioned within said housing and further comprising:
a float ball;
a float arm;
an elastomer seal member; and
a float limiting collar; and
a support member positioned to provide support for said float limiting collar when no vacuum is applied to said fluid-receiving chamber.

11. The float box according to claim 10, wherein said float mechanism further comprises an attachment member to which said elastomer seal member is secured, said float limiting collar further being secured to said attachment member to be positioned between said attachment member and said support member.

12. The float box according to claim 11, wherein said elastomer seal member is attached to said plenum, in proximity to said vacuum ports.

13. The float box according to claim 10, further comprising a vacuum filter collar positioned about said open bottom portion of said fluid-receiving chamber.

14. An impeller for a centrifugal pump, comprising
a hub for operative securement to a drive shaft of a centrifugal pump;
a back shroud extending radially from said hub, said back shroud having an outer peripheral edge defining a peripheral edge of said impeller; and
a plurality of vanes extending from proximate said hub to said peripheral edge of said impeller, each said vane having a leading edge oriented in proximity to said peripheral edge and having an outermost region of said leading edge positioned in proximity to said peripheral edge,
wherein the outermost region of each said vane of said plurality of vanes is backfiled to provide an angle of between about 15 degrees and about 33 degrees relative to a tangent line formed along said peripheral edge.

15. The impeller according to claim 14, wherein each said vane has a thickness defined along the length of said vane, and wherein each said vane has an increased thickness beginning from said outermost region of said leading edge toward said hub.

16. The impeller according to claim 15, wherein said impeller is cast of High Chrome.

17. The impeller according to claim 14, wherein said backfiled outermost portion of said leading edge of each said vane is cast of High Chrome.
